(19) United States
(12) Patent Application Publication
(10) Pub. No.: US 2010/0027400 A1
(43) Pub. Date: Feb. 4, 2010

(54) MOTION LIMITING COVER FOR DATA STORAGE DEVICE

(75) Inventors: Hong Zhu, Bloomington, MN (US); Roy Lynn Wood, Jordan, MN (US); James Roger Mahoney, Stewart, MN (US); Gene Allyn Thompson, Elko, MN (US); Peng Yan, Eagan, MN (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/354,911

(22) Filed: Jan. 16, 2009

Related U.S. Application Data
(60) Provisional application No. 61/137,419, filed on Jul. 30, 2008.

(51) Int. Cl. G11B 33/02

(52) U.S. Cl. 369/78; G9B/33.002

(57) ABSTRACT

Disclosed herein are embodiments of motion limiting cover features that improve coil/VCM coupled resonance. The features are flexible in that their position and configuration can be customized to specifically target a certain type of undesirable motion, such as undesirable twisting (i.e., torsion) and/or bending.

The present application is based on and claims the benefit of U.S. provisional patent application Ser. No. 61/137,419, filed Jul. 30, 2008, the content of which is hereby incorporated by reference in its entirety.

### BACKGROUND

Very accurate hard disk drive (HDD) servo control mechanisms are developed in the disk drive industry to meet the increasing tracks per inch (TPI) capability for higher areal data density. From a servo-mechanical design point of view, it is desirable for low frequency mechanical modes to be well attenuated to maintain the desired loop shape for tracking and op-vibe optimizations. It has been observed that low frequency coil torsion modes can raise issues in terms of tracking stability. There can be at least two kinds of coil torsion issues: 1) large population issues due to less than desirable design attributes; and 2) a relatively smaller percentage of outlier issues due to unclear causes which may include, not by limitation, issues related to parts tolerance, assembly tolerance and/or coupling variability between different components. Relatively little attention has been given to successfully addressing the latter outlier issues. Since there could be multiple causes, the yielding rate can be difficult to predict. For example, voice coil motor (VCM) alignment, top pole clocking direction, cover to VCM torque, latching pin interference, and so on all impact the yield at least to some degree. To improve on one aspect or fix drives under small sample size does not guarantee a significant production yielding rate improvement. Yield loss due to coil torsion tends to continue to be a significant issue regardless.

### SUMMARY

Embodiments of the present invention pertain to motion limiting cover features that improve coil/VCM coupled resonance. The features are flexible in that their position and configuration can be customized to specifically target a certain type of undesirable motion, such as undesirable twisting (i.e., torsion) and/or bending.

One particular embodiment pertains to a data storage device that includes a housing with a top cover configured to be secured to a base deck. The top cover includes a motion limiting feature configured to attenuate coil/VCM (voice coil motor) coupling resonance. A VCM is positioned within a VCM region of the housing such that securing the top cover to the base deck positions the motion limiting feature over the VCM region.

Another embodiment pertains to a top cover configured for attachment to a base deck so as to form a housing portion of a data storage device. A motion limiting feature is formed within the top cover. The motion limiting feature is separate and distinct from any connector opening formed within the top cover. The motion limiting feature is configured to attenuate coil/VCM (voice coil motor) coupling resonance when the top cover is integrated into a fully functioning data storage device.

Yet another embodiment pertains to a method of attenuating coil/VCM (voice coil motor) coupling resonance within an operating data storage device. The method includes directly forming a motion limiting feature on a surface of a top cover the data storage device, the motion limiting feature being separate and distinct from any connector opening formed within the top cover.

These and various other features and advantages that characterize the claimed embodiments will become apparent upon reading the following detailed description and upon reviewing the associated drawings.

### BRIEF DESCRIPTION OF THE DRAWINGS

FIG. 1 is an exploded view of a data storage device constructed and operated in accordance with exemplary embodiments.

FIG. 2 is a generalized functional block diagram of the device of FIG. 1.

FIG. 3 is an exploded representation of a voice coil motor.

FIG. 4A is a top view of a top cover that incorporates a slot.

FIG. 4B is a top view of a top cover that incorporates a slot.

FIG. 4C is a cross section view from the perspective of line 4C in FIG. 4A.

FIG. 5A is a top view of a top cover that incorporates a rib.

FIG. 5B is a top view of a top cover that incorporates two ribs.

FIG. 5C is a top view of a top cover that incorporates a rib.

FIG. 5D is a top view of a top cover that incorporates a rib.

FIG. 5E is a cross section view from the perspective of line 5E in FIG. 5C.

FIG. 6 is a top view of a top cover that incorporates an attached shim.

FIG. 7A is a top view of a top cover that incorporates a boss.

FIG. 7B is a cross section view from the perspective of line 7B in FIG. 7A.

### DETAILED DESCRIPTION

Motion related to coil/VCM (voice coil motor) coupled resonance is known to negatively affect performance of a data storage device. There have been proposals to limit motion by re-designing the housing to include more connectors intended to add additional stability to the coil/VCM coupling. However, adding more connectors is a very expensive way to address the motion issue. Described herein are embodiments of motion limiting cover features that enable motion limitation without an addition of extra connectors such as screws. The motion limiting cover features provide an effective and relatively inexpensive way to combat negative motion issues.

As examples of the type of motion limiting features contemplated, the present description is directed to, not by limitation, embodiments of an opening, a rib, a boss, or a ship positioned on or within a top cover of a data storage device. Each feature is separate and distinct from any connector opening formed within the top cover. The motion limiting feature are configured to attenuate coil/VCM (voice coil motor) coupling resonance when the top cover is integrated into a fully functioning data storage device.

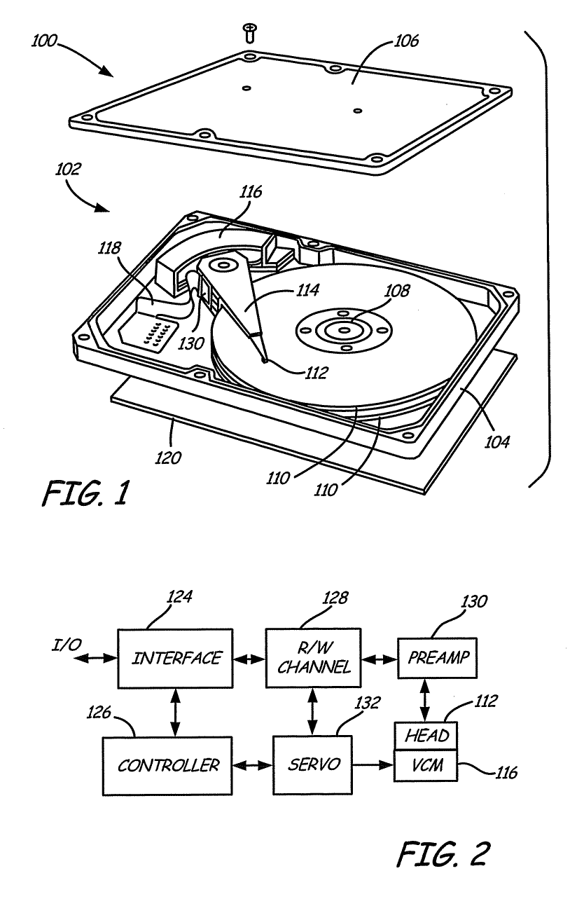

FIG. 1 shows an exploded view of a data storage device 100 to provide an exemplary environment in which exemplary embodiments can be advantageously practiced. The device 100 is preferably characterized as a hard disc drive of the type used to store and retrieve digital data in a computer system or network, consumer device, etc.

The device 100 includes a rigid, environmentally controlled housing 102 formed from a base deck 104 and a top cover 106. A spindle motor 108 is mounted within the housing 102 to rotate a number of data storage media 110 at a relatively high speed.

Data are arranged on the media 110 in concentric tracks, which are accessed by a corresponding array of data transducing heads 112. The heads 112 (transducers) are supported by an actuator 114 and moved across the media surfaces by application of current to a voice coil motor, VCM 116. A flex circuit assembly 118 facilitates communication between the actuator 114 and control circuitry on an externally mounted printed circuit board, PCB 120.

As shown in FIG. 2, the control circuitry preferably includes an interface circuit 124 that communicates with a host device using a suitable interface protocol. A top level processor 126 provides top level control for the device 100 and is preferably characterized as a programmable, general purpose processor with suitable programming to direct the operation of the device 100.

A read/write channel 128 operates in conjunction with a preamplifier/driver circuit (preamp) 130 to write data to and to recover data from the discs 108. The preamp 130 is preferably mounted to the actuator 114 as shown in FIG. 1. A servo circuit 132 provides closed loop positional control for the heads 112.

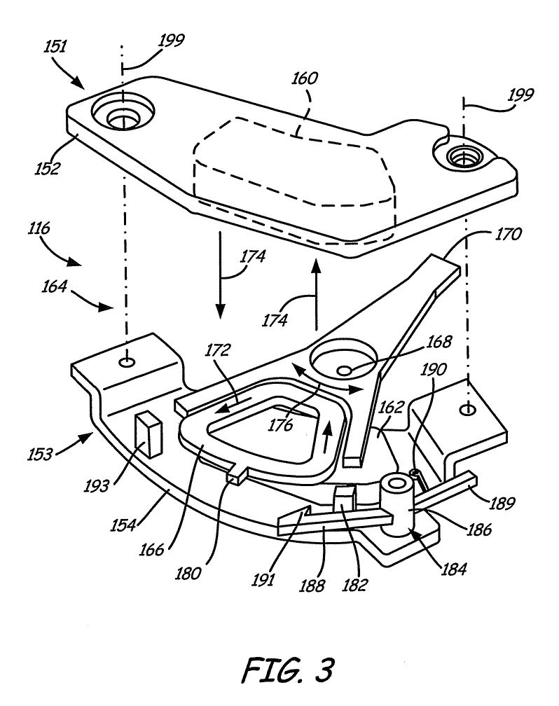

Within FIG. 1, components in the area of VCM 116 are very generally depicted and may not make completely apparent the type of motion that occurs in the area of VCM 116 during disc drive operation. FIG. 3 is a more detailed exploded representation of a VCM 116. The VCM 116 includes a top pole assembly 151 and a bottom pole assembly 153. Top pole assembly 151 includes an upper plate 152 and a permanent magnet 160 that is joined to upper plate 152. Bottom pole assembly 153 includes a lower plate 154 and a permanent magnet 162 that is joined to lower plate 154. An air gap 164 is formed between permanent magnets 160 (hidden by upper plate 152) and 162. A voice coil 166 is rotationally mounted to an axle 168 and also mounted to transducer heads (not shown in FIG. 3) attached to the end of arm 170 (which is part of head assembly 112 shown in FIG. 1). An electric current 172 is passed through voice coil 166. Current 172 interacts with magnetic field 174 in the air gap 164 to rotate the voice coil as shown by arrow 176.

When the transducer heads are to be parked, a current is passed through voice coil 166 to rotate the voice coil such that tab 180 is engaged by primary latch 182. Primary latch 182 includes a magnet and tab 180 includes a magnetic material. Thus, tab 180 remains engaged by primary latch 182 even when the energization current is removed from voice coil 166. Secondary or inertial latch 184 includes a hub 186 and a latch arm 188. A magnetic detent 190 near the distal end 189 of latch arm 188 interacts with a fringing magnetic field near the edge of the air gap 164 between permanent magnets 160, 162. The interaction of magnetic detent 188 with the fringing field exerts a detent force on magnetic detent 190 that, in turn, generates a detent torque on the latch arm 188, which holds inertial latch 184 in an unlatched position in the absence of high level shocks applied to the disc drive. The magnetic detent 188 is a sphere of magnetic material with a diameter that has been reduced so that it will fit in the narrow air gap 164. When a high level shock is applied to the disc drive, the force on inertial latch 184 is sufficient to overcome the detent force and therefore inertial latch 184 rotates in response to the applied force such that hook 191 of inertial latch 184 engages tab 180. When the shock level reduces, the detent force exerted on inertial latch 184 causes hook 191 to release tab 180. VCM 118 also includes a first post 193, which is formed of any suitable metal or plastic, that limits the rotation of voice coil 166 such that transducer heads 110 do not move beyond outer disc diameter 126 (FIG. 1). A second post (not shown) may be included between the distal end 189 of latch arm 188 and permanent magnet 162 to limit the movement of latch arm 188.

FIG. 3 also shows connector paths 199. Those skilled in the art will appreciate that a connector (not shown) is illustratively inserted through openings in plates 152 and 154 so as to secure together the various components of the VCM 116. Those skilled in the art will also appreciate that top cover 106 will sometimes include one or more connector openings (not shown in FIG. 1) that correspond to one or more of the connector paths 119. In such a case, the connector will also pass through the top cover 106 such that top cover essentially becomes secured to the VCM 116. In most cases, the distal end of the connector will securely engage to lower plate 154 and/or to a connector positioned beneath plate 154 and in line with the connector opening in the plate. Regardless of the particular attachment scheme, those skilled in the art will appreciate that a connector is utilized to secure together the components having inline connector openings along the connector path 199. The components that are secured together illustratively can include any combination of a top cover 106, a VCM upper plate 152, a VCM lower plate 154, and may include a connection mechanism beneath lower plate 152. In certain embodiments, one connector path accommodates a VCM screw and the other path accommodates an actuator pivot screw.

As an alternative to searching for and addressing ghost root causes for coil torsion, certain embodiments of the present invention pertain to motion limiting cover features that improve coil/VCM coupled resonance. The features are relatively small and inexpensive to implement, and are flexible in that their position and configuration can be customized to specifically target any type of undesirable motion, such as undesirable twisting (i.e., torsion) and/or bending.

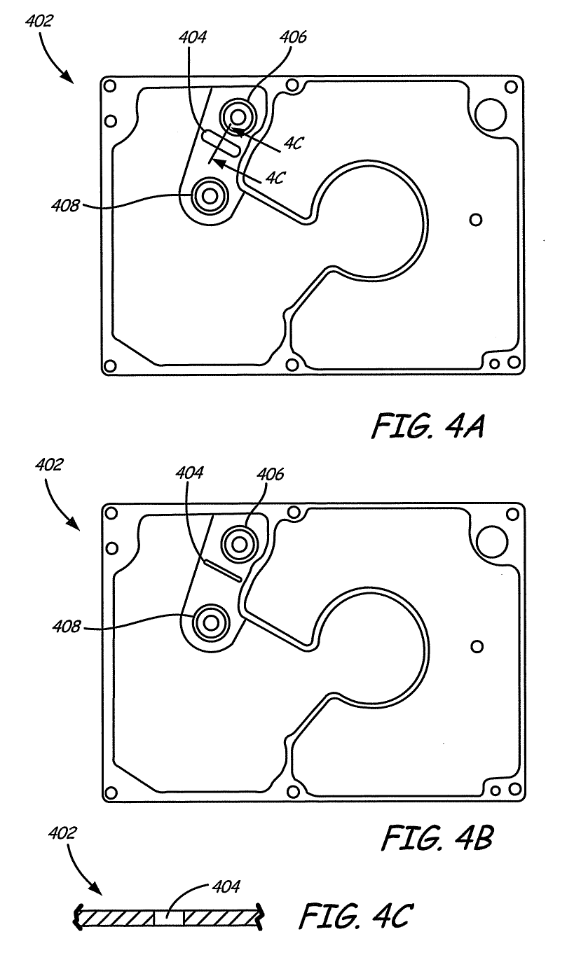

In certain embodiments of a motion limiting cover feature, an opening is made all the way through a top cover (e.g., top cover 106 in FIG. 1). FIG. 4A is a top view of a top cover 402 that incorporates a slot 404 positioned between a first connector opening 406 and a second connector opening 408. The surface of top cover 402 shown in FIG. 4A is illustratively the surface that is opposite (i.e., not adjacent to) the internal disk drive components when the disk drive is fully assembled. Those skilled in art the will appreciate that openings 406 and 408 extend all the way through top cover 402. These openings are illustratively configured to align with a connector path (e.g., connector paths 199 in FIG. 3) in the context of a connection scheme wherein cover 406 is secured with a connector to any combination of a VCM upper plate (e.g., plate 152 in FIG. 3), a VCM lower plate (e.g., plate 154), and possibly a connection mechanism beneath a lower plate. Slot 404 is illustratively a “pill-shaped” opening that extends all the way through cover 402. FIG. 4C is a cross section from the perspective of line 4C in FIG. 4A. FIG. 4C is a clarification, for illustrative purposes, of the nature of slot 404.

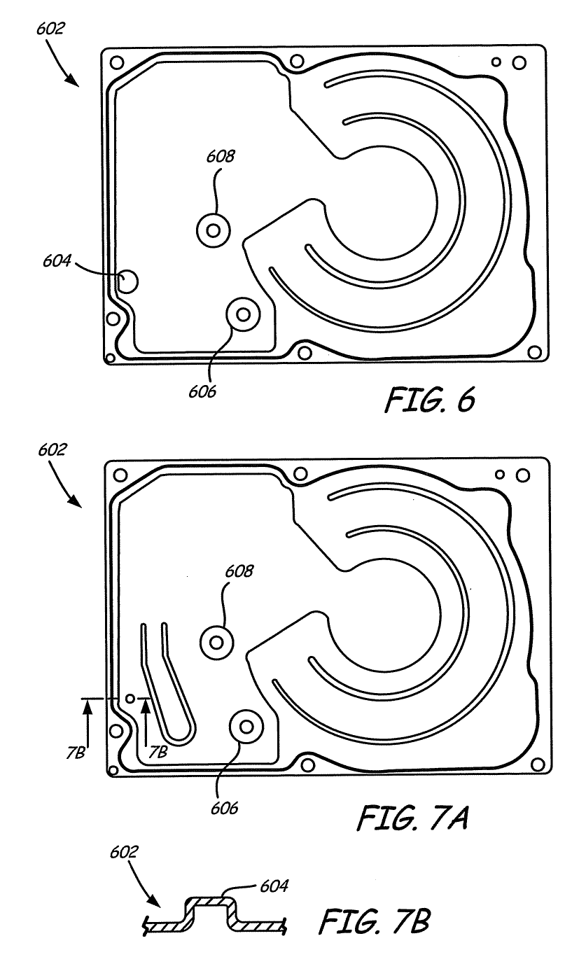

It is to be understood that the present invention is not limited to a slot having the precise position and configuration as the illustrated slot 404. FIG. 4B shows another embodiment of plate 402, this time with a slot 404 having a different shape. The scope of the present invention is not limited to a “pill-shaped” slot (e.g., the opening could just as easily be in the shape of a circle, a square, a zigzag, a rectangle or any other shape). Further, the present invention is not limited to placement of the opening between two connector holes (or even proximate to one connector hole). A slot could just as easily be positioned close to the perimeter edges of the top cover, or near an edge of the VCM area similar to placement of a shim 604 that will be described in relation to FIG. 6. Different opening shapes and placements will have different impact in terms of motion limiting benefits. Some configurations and positions will have more affect on twisting (i.e., torsion) motion, while others will have more impact on bending motion. The most desirable position/configuration will likely vary from one implementation to the next, from one disk drive design to the next. In certain embodiments, the width (i.e., the dimension that varies between FIGS. 4A and 4B) of the illustrated slot 404 is somewhere in the range of 50-100 mil, though the present invention certainly contemplates measurements outside of this range. It should also be noted that the present invention is not limited to having a single opening. Depending on a given implementation, it may be most desirable to have multiple openings.

It should be noted that adding a slot in a manner as demonstrated in FIGS. 4A and 4B illustratively affects motion by weakening the in plane stiffness of cover 402 and by cutting the transmission path between the connectors (e.g., screws) fixed within connector openings 406 and 408 when the data storage device is completely assembled. In certain embodiments, this means interrupting transmission of motion between a VCM screw and an actuator pivot screw. Positioning the slot as illustrated has specifically been proven to improve coil torsion in certain disk drive designs. However, it becomes possible for undesirable particles to enter the disk drive through such an opening into the top cover. Thus, such an opening creates a potential particle contamination concern. In certain embodiments, however, the slot is partially or completely sealed shut in order to block contamination that might otherwise enter the disk drive housing.

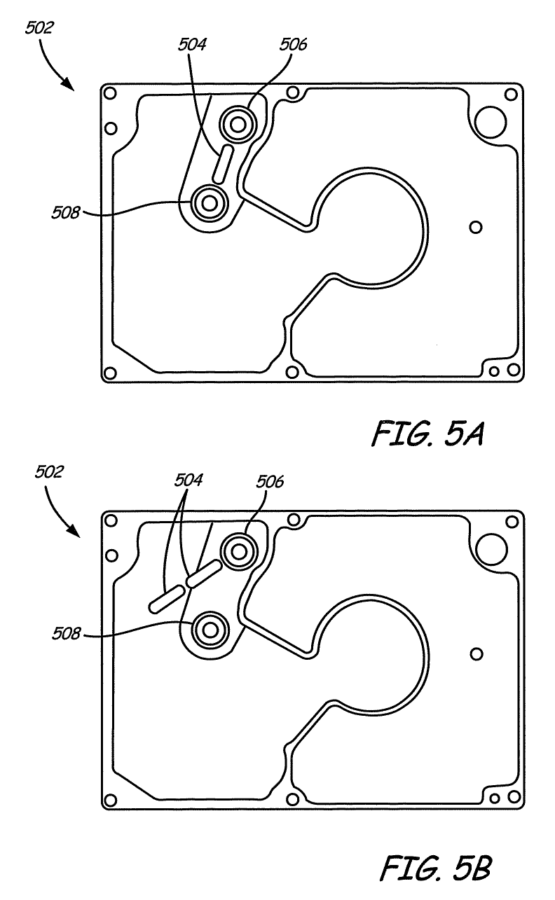

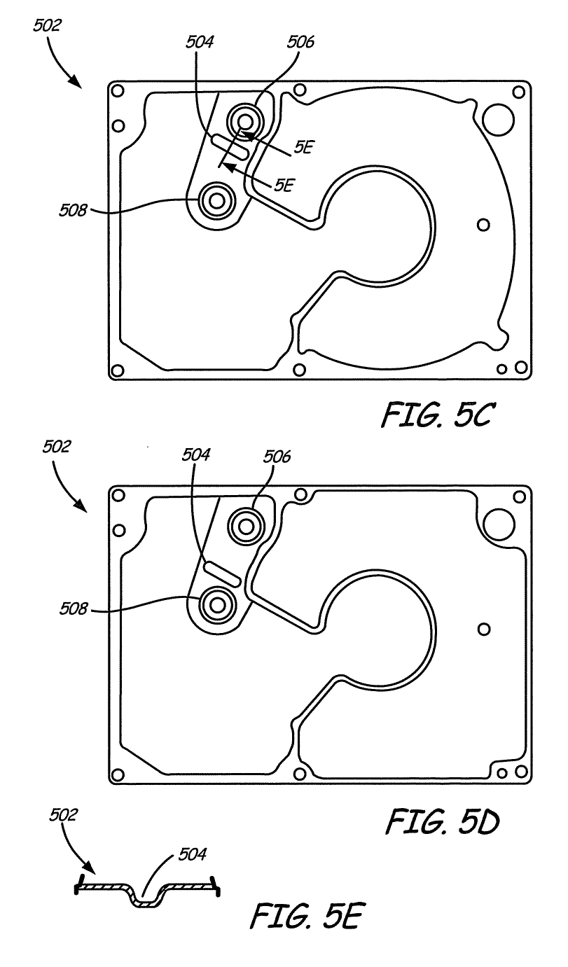

In certain embodiments of a motion limiting cover feature, a rib is added to a top cover (e.g., top cover 106 in FIG. 1). FIG. 5A is a top view of a top cover 502 that incorporates a rib 504 positioned between a first connector opening 506 and a second connector opening 508. The surface of top cover 502 shown in FIG. 5A is illustratively the surface opposite (i.e., not adjacent to) the internal disk drive components when the disk drive is filly assembled. On the illustrated side of top cover 502, rib 504 is a recession formed within the cover surface. The opposite side of top cover 502 includes a protrusion that, when the disk drive is filly assembled, extends out from the surface of the top cover immediately proximate to the rib (i.e., extends toward the disk drive components. The recession on the “outside” surface of the top cover corresponds to a raised rib on the “inside” surface of the top cover, the inside surface being adjacent to the disk drive components when the disk drive is filly assembled. In certain embodiments, rib 504 is stamped into cover 504 through an exertion of force on the side of the top cover shown in FIG. 5A.

Rib 504 is similar to the previously described slot 404 but is a protrusion from the top cover surface rather than an opening formed therein. It should be noted that it is also within the scope of the present invention for the direction of the protruding nature of rib 504 to be reversed such that feature 504 is an indention on (i.e., rather than a protrusion from) the surface of the top cover that faces the disk drive components. For example, feature 504 could be stamped from the opposite side of top cover 502 in order to form an indention feature rather than a protrusion feature. Both variations are contemplated as alternatives for positively impacting negative motion concerns. With regard to openings 506 and 508, one skilled in the art will appreciate that these openings are essentially equivalent to the openings 406 and 408 described in relation to FIGS. 4A and 4B.

It is to be understood that the present invention is not limited to a rib having the precise position and configuration as the illustrated rib 504. FIGS. 5B, 5C and 5D show another embodiment of plate 502, this time with different rib configurations. The scope of the present invention is not limited to a “pill-shaped” rib (e.g., the rib could just as easily be in the shape of a circle, a square, a zigzag, a rectangle or any other shape). Further, the present invention is not limited to placement of the rib between two connector holes (or even proximate to one connector hole). A rib could just as easily be positioned close to the perimeter edges of the top cover, or near an edge of the VCM area similar to placement of a shim 604 that will be described in relation to FIG. 6. Different rib shapes and placements will have different impact in terms of motion limiting benefits. Some configurations and positions will have more affect on twisting (i.e., torsion) motion, while others will have more impact on bending motion. The most desirable position/configuration will vary from one implementation to the next. As the Figures illustrate, the present invention is also not limited to having a single rib. Depending on a given implementation, it may be most desirable to have two or even more ribs.

It should be noted that adding a rib in a manner as described herein (e.g., FIGS. 5A and 5B) enables a weakening of the in plane stiffness of cover 502. Also, when a rib cuts between the connector openings (e.g., FIGS. 5C and 5D), this cuts the transmission path between the connectors (e.g., screws) fixed within connector openings 506 and 508 when the data storage device is completely assembled. In certain embodiments, this means interrupting transmission of motion between a VCM screw and an actuator pivot screw. FIG. 5E is a cross section from the perspective of line 5E in FIG. 5C. FIG. 5E is a clarification, for illustrative purposes, of the nature of feature 504.

In certain embodiments of a motion limiting cover feature, a shim is added to a top cover (e.g., top cover 106 in FIG. 1). FIG. 6 is a top view of a top cover 602 having an attached shim 604 positioned, as illustrated in FIGS. 4 and 5, such that they will be above the VCM region of the disc drive when the drive is fully assembled. The surface of top cover 602 shown in FIG. 6 is illustratively the surface adjacent to the disk drive components when the disk drive is fully assembled. Shim 604 is illustratively a protrusion that, when the disk drive is fully assembled, extends out from the surface of the top cover immediately proximate to the shim (i.e., toward the internal disk drive components). In certain embodiments, shim 604 is a piece of metal or plastic attached to the illustrated surface of cover 604. Accordingly, in this case, the outer surface of top cover 602 is not likely to have any corresponding indention because shim 604 is a separately attached piece instead of being stamped in, was described in relation to ribs 504. Shim 604 is similar to the previously described ribs 504 in that it is a protrusion from the top cover surface (toward the internal disk drive components when the disk drive is fully assembled) rather than an opening formed therein. With regard to openings 606 and 608, one skilled in the art will appreciate that these openings are essentially equivalent to the openings 406 and 408 described in relation to FIGS. 4A and 4B.

It is to be understood that the present invention is not limited to a shim having the precise position and configuration as the illustrated shim 604. The scope of the present invention is not limited to a circular shim as illustrated (e.g., the shim could just as easily be in the shape of a circle, a square, a zigzag, a rectangle or any other shape). Further, the present invention is not limited to placement of the shim proximate the edge of the VCM area as illustrated. A shim could just as easily be positioned between the connector openings as has been described in relation to other embodiments. Different shim shapes and placements will have different impact in terms of motion limiting benefits. Some configurations and positions will have more affect on twisting (i.e., torsion) motion, while others will have more impact on bending motion. The most desirable position/configuration will vary from one implementation to the next. The present invention is also not limited to having a single shim. Depending on a given implementation, it may be most desirable to have two or even more shims.

While the present invention is not limited to a shim of any particular dimension, in certain embodiments, an incorporated metal shim is circular with a thickness of 25 mils and a diameter of ⅛ inch. In certain embodiments, the position of the shim in FIG. 6 is effective in terms of reducing coil torsion, thereby providing a solution for coil torsion failures.

Utilizing a rubber shim provides a damping effect not provided by a metal shim. While the present invention is not limited to a shim of any particular dimension, in certain embodiments, an incorporated rubber shim is circular with a thickness of 55 mils and a diameter of 3/16 inch. Other diameters, such as 45 mil, may be equally effective. Again, the position of the shim in FIG. 6 is effective in terms of reducing coil torsion, thereby providing a solution for coil torsion failures.

In certain embodiments of a motion limiting cover feature, a boss is added to a top cover (e.g., top cover 106 in FIG. 1). FIG. 7A is a top view of a top cover 702 that incorporates a boss 704 positioned, as illustrated in FIGS. 4, 5, and 6, such that they will be above the VCM region of the disc drive when the drive is fully assembled. The surface of top cover 702 shown in FIG. 7A is illustratively the surface adjacent to the disk drive components when the disk drive is fully assembled. Shim 704 is illustratively a protrusion that, when the disk drive is fully assembled, extends out from the surface of the top cover immediately proximate to the shim (i.e., toward the internal disk drive components).

The surface of top cover 702 not shown in FIG. 7A is the surface opposite (i.e., not adjacent to) the internal disk drive components when the disk drive is fully assembled. On the not illustrated side of top cover 702, boss 704 is a recession formed within the cover surface. The recession on the “outside” surface of the top cover corresponds to a raised boss on the “inside” surface of the top cover, the inside surface being adjacent to the disk drive components when the disk drive is fully assembled. In certain embodiments, boss 704 is stamped into cover 704 through an exertion of force on the side of the top cover not shown in FIG. 7A.

Boss 704 is similar to the previously described shim 604 but is formed via indention or stamping rather than attachment of a separate piece. It should be noted that it is also within the scope of the present invention for the direction of the protruding nature of boss 704 to be reversed such that feature 704 is an indention on (i.e., rather than a protrusion from) the surface of the top cover that faces the disk drive components upon complete assembly. For example, feature 704 could be stamped from the opposite side of top cover 702 in order to form an indention feature rather than a protrusion feature. Both variations are contemplated as alternatives for positively impacting negative motion concerns. With regard to openings 706 and 708, one skilled in the art will appreciate that these openings are essentially equivalent to the openings 406 and 408 described in relation to FIGS. 4A and 4B. FIG. 7B is a cross section from the perspective of line 7B in FIG. 7A. FIG. 7B is a clarification, for illustrative purposes, of the nature of the boss feature.

It is to be understood that the present invention is not limited to a boss having the precise position and configuration as the illustrated boss 704. The scope of the present invention is not limited to the circular boss (e.g., the rib could just as easily be in the shape of a pill, a square, a zigzag, a rectangle or any other shape). Further, the boss could just as easily be positioned between connector openings similar to positioning of slots described in relation to FIG. 4. Different boss shapes and placements will have different impact in terms of motion limiting benefits. Some configurations and positions will have more affect on twisting (i.e., torsion) motion, while others will have more impact on bending motion. The most desirable position/configuration will vary from one implementation to the next. Still further, the present invention is also not limited to having a single boss. Depending on a given implementation, it may be most desirable to have two or even more bosses.

Utilizing a stamped boss has advantages over attachment of a metal or rubber shim. A boss can be stamped for little or no cost and the positioning is very accurate. Incorporating a boss has proven to be effective in terms of providing a remedy for both coil torsion and coil bending. Location of a boss or bosses can be selected from one disk drive to the next so as to optimize the effect on a particular type of motion.

What is claimed is:

1. A data storage device, comprising:
a housing that includes a top cover configured to be secured to a base deck, the top cover including a motion limiting feature configured to attenuate coil/VCM (voice coil motor) coupling resonance; and
a VCM positioned within a VCM region of the housing such that securing the top cover to the base deck positions the motion limiting feature over the VCM region.

2. The data storage device of claim 1, wherein the motion limiting feature is a rib.

3. The data storage device of claim 2, wherein the motion limiting feature is a rib that is stamped into the top cover.

4. The data storage device of claim 2, wherein the rib is positioned between two connector openings formed in the top cover.

5. The data storage device of claim 1, wherein the rib protrudes from a surface of the top cover so as to extend toward the VCM region when the top cover is secured to the base deck.

6. The data storage device of claim 1, wherein the motion limiting feature is a boss.

7. The data storage device of claim 6, wherein the motion limiting feature is a boss that is stamped into the top cover.

8. The data storage device of claim 6, wherein the boss is positioned closer to an outer perimeter of the top cover than to any connector opening formed within the top cover.

9. The data storage device of claim 6, wherein the boss protrudes from a surface of the top cover.

10. The data storage device of claim 1, wherein the motion limiting feature is a shim attached to a surface of the top cover.

11. The data storage device of claim 10, wherein the motion limiting feature is a metal shim.

12. The data storage device of claim 10, wherein the motion limiting feature is a rubber shim.

13. The data storage device of claim 10, wherein the shim is positioned closer to an outer perimeter of the top cover than to any connector opening formed within the top cover.

14. The data storage device of claim 6, wherein the shim protrudes from a surface of the top cover.

15. The data storage device of claim 1, wherein the motion limiting feature is a slot.

16. The data storage device of claim 15, wherein the slot is at least partially sealed.

17. A top cover that is configured to be attached to a base deck so as to form a housing portion of a data storage device, wherein a motion limiting feature is formed within the top cover, the motion limiting feature being separate and distinct from any connector opening formed within the top cover, and wherein the motion limiting feature is configured to attenuate coil/VCM (voice coil motor) coupling resonance when the top cover is integrated into a fully functioning data storage device.

18. The top cover of claim 17, wherein the motion limiting feature is stamped into the top cover.

19. A method of attenuating coil/VCM (voice coil motor) coupling resonance within an operating data storage device, the method comprising directly forming a motion limiting feature on a surface of a top cover the data storage device, the motion limiting feature being separate and distinct from any connector opening formed within the top cover.

20. The method of claim 19, wherein forming comprises stamping the motion limiting feature into the top cover.
